(19) United States
(12) Patent Application Publication
(10) Pub. No.: US 2009/0008200 A1
(43) Pub. Date: Jan. 8, 2009

(54) Negative Pressure Type Booster Device

(76) Inventors: Kaoru Tsubouchi, Aichi (JP); Yoji Inoue, Aichi (JP); Koichi Hashida, Aichi (JP); Tomoyasu Sakai, Aichi (JP)

Correspondence Address: BUCHANAN, INGERSOLL & ROONEY PC, POST OFFICE BOX 1404, ALEXANDRIA, VA, 22313-1404, US

(21) Appl. No.: 10/581,931

(22) PCT Filed: Jan. 12, 2006
(86) PCT No.: PCT/JP2006/300669

§ 371 Date: Jun. 7, 2006

(30) Foreign Application Priority Data
Jan. 12, 2005 (JP) 2005-004979
Mar. 24, 2005 (JP) 2005-085928
Jun. 27, 2005 (JP) 2005-186065

(51) Int. Cl. B60T 11/00

(52) U.S. Cl. 188/356

(57) ABSTRACT

To provide a negative pressure type booster device which has a high responsiveness even when a brake pedal is stepped on strongly and which is simplified and compact in construction. To this end, a passage 45 communicating directly with the atmosphere is provided between the internal surface of a sliding cylindrical portion 8b of a valve piston 8 and the external surface of a silencer 27, and the atmospheric air is enabled to be admitted from the passage 45 to a variable pressure chamber 6 directly without passing through the silencer 27 when an input member is advanced beyond a predetermined distance relative to the valve piston.

### TECHNOLOGICAL FIELD

The present invention relates to a negative pressure type booster device for vehicles and particularly, to a negative pressure type booster device capable of being highly responsive when a brake pedal is stepped on strongly.

### BACKGROUND ART

Generally, in negative pressure type booster devices, when the stepping of a brake pedal advances an input rod which thus causes a plunger to advance relative to a valve piston, a negative pressure valve comes into contact with a negative pressure valve seat to block the communication between a variable pressure chamber and a constant pressure chamber. When the plunger is further advanced then, an atmosphere valve seat and an atmosphere valve are separated, whereby the atmospheric air is admitted from the surrounding atmosphere to the variable pressure chamber through a silencer and a filter element. Thus, the valve piston is moved forward in dependence on a pressure difference between the variable pressure chamber and the constant pressure chamber to push a master piston, whereby a brake pressure corresponding to the steeping force of the brake pedal is generated in the master cylinder.

Since the valve piston elastically deforms a reaction member by an operation power corresponding to the pressure difference between the variable pressure chamber and the constant pressure chamber to push the master piston, the reaction member under the elastic deformation pushes the plunger rearward. This causes the plunger to retract so that the atmosphere valve seat is seated on the atmosphere valve to block the communication of the variable pressure chamber with the atmosphere and hence, to hold the brake oil pressure at a desired pressure.

By the way, although it is required to admit the atmospheric air to the variable pressure chamber without delay when the brake pedal is stepped on strongly, it is impossible due to an air path resistance of the silencer to admit a sufficient volume of the atmospheric air to the variable pressure chamber, and this makes the cause of difficulty in enhancing the responsiveness in braking operation. Particularly, improvement has been required these days with an increasing desire for shortening the time for vehicle to stop after braking.

As one satisfying such desire, there has been known a negative pressure type booster device as described in Japanese examined, published patent No. 6-24922. In the device described in the patent, a sleeve is provided around a valve housing (valve piston), and an additional annular air passage is defined between the sleeve and the valve housing to open to a rearward chamber (variable pressure chamber). An additional valve member is formed at the rear end of the sleeve and is biased toward a third valve seat so that the same is usually held closed by the additional valve member. Then, when a brake pedal is stepped on sharply, the valve member formed at the rear end of the sleeve is separated from the third valve seat. This causes the atmospheric air from a filter element not only to flow into the rearward chamber through an inner space and an intermediate space, but also to flow into the rearward chamber through the additional air passage. As a consequence, the pressure in the rearward chamber rapidly comes to be equal to the atmospheric air, so that the braking responsiveness can be enhanced.

However, in the device described in the aforementioned patent, a problem arises in that the negative pressure type booster device is enlarged in dimension by the provision of the sleeve which defines the additional air passage around the valve housing (valve piston). Further, the third valve seat has to be newly provided for making the additional air passage communicate with, or blocked from, the atmosphere, and this gives rise to another problem that the reliability of the product is deteriorated. In addition, the valve housing and the sleeve are required to be slidable independently, and all the loads acting on the valve housing is exerted on a support portion for supporting such sliding movements. Thus, it is very difficult to make the sliding movements performed smoothly, which undesirably results in the difficulty in maintaining the initial performance stable.

The present invention has been made to solve the foregoing problems involved in the prior art, and it is an object of the present invention to provide a negative pressure type booster device which is high in responsiveness and which is simplified and compact in construction.

### DISCLOSURE OF THE INVENTION

Briefly, according to the present invention, there is provided a negative pressure type booster device, which comprises a booster shell movably supporting a partition member which partitions the interior of the booster shell into a variable pressure chamber and a constant pressure chamber; a valve piston secured to the partition member at a base portion thereof and having a negative pressure valve seat formed thereon for selective communication of the variable pressure chamber with the constant pressure chamber; an output rod connected to the valve piston; a reaction member for transmitting an output of the partition member depending on the pressure difference between the variable and constant pressure chambers, from the valve piston to the output rod; a plunger operable in connection with the reaction member and having an atmosphere valve seat formed thereon; an input rod connected to the plunger for axially moving the plunger when the input rod is axially moved by a brake pedal; a valve member having a negative pressure valve and an atmosphere valve formed thereon, the negative pressure valve being contactable with the negative pressure valve seat of the valve piston for making the variable pressure chamber communicate selectively with the constant pressure chamber, the atmosphere valve being contactable with the atmosphere valve seat of the plunger for making the variable pressure chamber communicate selectively with the atmosphere; and a silencer disposed in a passage for leading the atmospheric air to the atmosphere valve. In the negative pressure type booster device, a secondary passage communicating directly with the atmosphere is formed between an internal surface of a sliding cylindrical portion of the valve piston and an external surface of the silencer for enabling the atmospheric air to be admitted from the secondary passage to the variable pressure chamber when the input rod is advanced beyond a predetermined distance relative to the valve piston.

With this construction, the secondary passage communicating directly with the atmosphere is formed between the internal surface of the sliding cylindrical portion of the valve piston and the external surface of the silencer, and the atmospheric air can be admitted from the secondary passage to the variable pressure chamber when the input rod is advanced relative to the valve piston beyond the predetermined distance. Thus, when the brake pedal is stepped on strongly or sharply, it can be realized to admit the atmospheric air from the secondary passage without passing through the silencer and hence, to enhance the responsiveness. In addition, since the secondary passage is formed inside the internal surface of the valve piston, the negative pressure type booster device can be made compact in construction, and the smooth operation can be ensured.

### BRIEF DESCRIPTION OF THE DRAWINGS

FIG. 1 is a sectional view of a negative pressure type booster device in the first embodiment according to the present invention.

FIG. 2 is a sectional view taken along the line A-A in FIG. 1 of a valve mechanism section.

FIG. 3 is a sectional view taken along the line B-B in FIG. 2.

FIG. 4 is a sectional view taken along the line C-C in FIG. 2.

FIG. 5 is a sectional view of a negative pressure type booster device in the second embodiment according to the present invention.

FIG. 6 is a sectional view taken along the line D-D in FIG. 5.

FIG. 7 is a sectional view of a negative pressure type booster device in the third embodiment according to the present invention.

FIG. 8 is an enlarged sectional view of an important part of FIG. 7.

FIG. 9 is a sectional view taken along the line E-E in FIG. 8.

FIG. 10 is an operation state view showing the state that an input member has been swung.

FIG. 11 is a sectional view taken along the line F-F in FIG. 10.

### PREFERRED EMBODIMENTS TO PRACTICE THE INVENTION

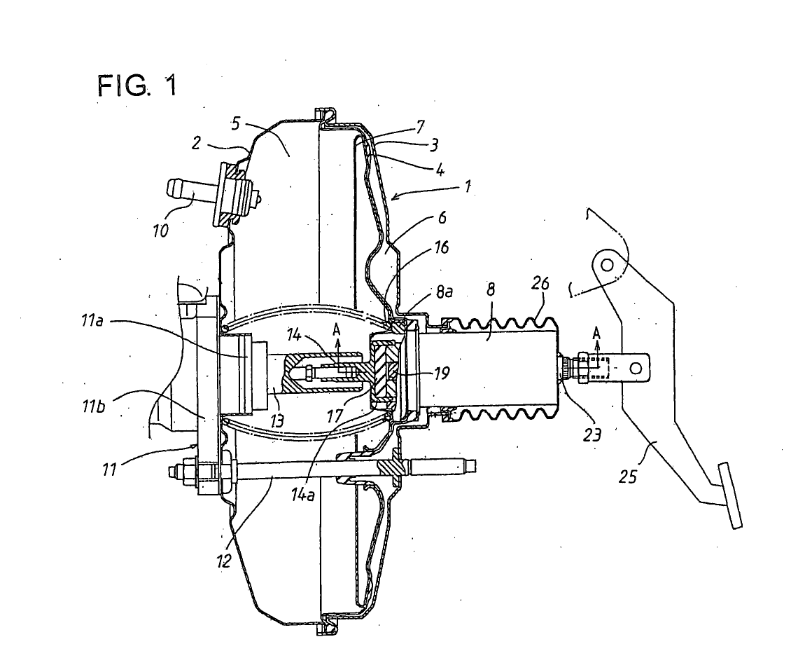

Hereinafter, a negative pressure type booster device in the first embodiment according to the present invention will be described with reference to the drawings. Referring to FIG. 1, a booster shell 1 is composed of a front shell 2 and a rear shell 3. Between the both shells 2 and 3, a flexible diaphragm 4 serving as partition member is secured air-tightly at its outer circumferential bead portion and partitions the interior of the booster shell 1 into a constant pressure chamber 5 and a variable pressure chamber 6. A disc-like plate 7 is laminated to the diaphragm 4 within the constant pressure chamber 5. A cylindrical valve piston 8 is air-tightly secured to the diaphragm 4 and the plate 7 at the outer surface of a base portion 8a thereof and exposes the forward end surface of the base portion 8a to the constant pressure chamber 5. A negative pressure leading conduit 10 is attached to the front shell 2, and the constant pressure chamber 5 is in communication with an intake manifold of an engine through the negative pressure leading conduit 10 thereby to be kept at a predetermined negative pressure during the operation of the engine.

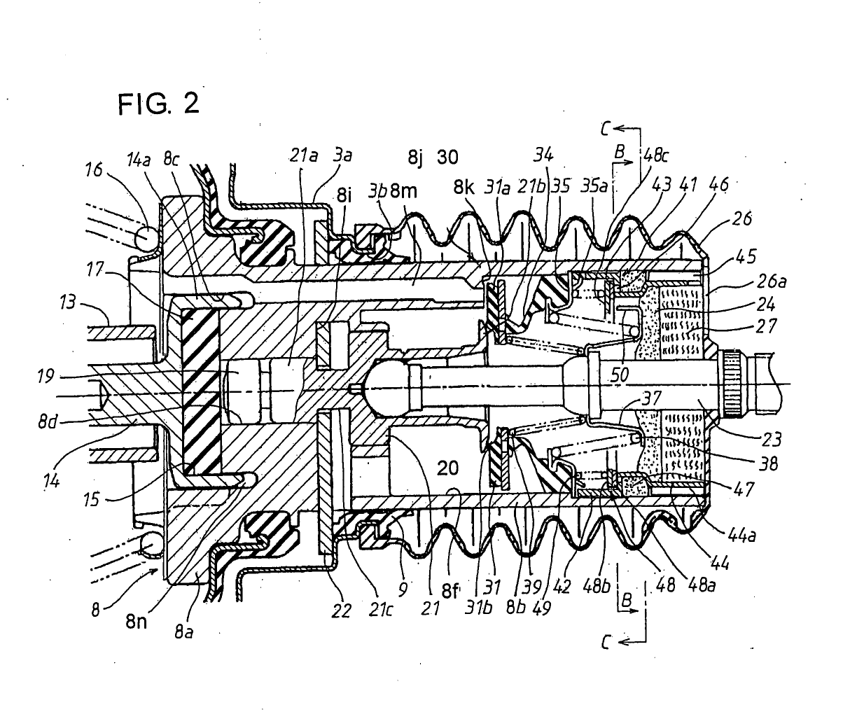

As shown in FIG. 2, the rear shell 3 is bent at its center portion outwardly thereby to protrude a cylindrical protruding portion 3a rearward and has a through hole 3b formed to extend on the axis of the rear shell 3. The valve piston 8 protrudes a sliding cylindrical portion 8b rearward from the base portion 8a, and the sliding cylindrical portion 8b passes through the through hole 3b to protrude rearward from the protruding portion 3a of the rear shell 3. A sealing element 9 is interposed between the internal surface of the through hole 3b and the outer surface of the sliding cylindrical portion 8b to block the variable pressure chamber 6 from the atmosphere.

As shown in FIG. 1, a numeral 11 denotes a master cylinder, which at its rear end portion 11a, passes through a center hole formed on the front shell 2 to air-tightly protrude into the constant pressure chamber 5, with a flange portion 11b thereof being in abutting engagement with the forward end surface of the front shell 2. The front shell 2 and the rear shell 3 are joined with each other with several (e.g., two) tie rods 12, each of which extends in parallel with the axis of the booster shell 1 composed of the both shells at almost radial mid position between the axis and the outer surface of the booster shell 1, and are secured to the master cylinder 11. A sliding hole of each sealing portion formed on the diaphragm 4 is fit on each tie rod 12 to be air-tightly slidable therealong as it keeps the air-tight partitioning between the constant pressure chamber 5 and the variable pressure chamber 6.

A numeral 13 denotes a master piston, which is inserted into the master cylinder 11 slidably in the forward-rearward direction. The master piston 13 protrudes from the rear end portion of the master cylinder 11 into the constant pressure chamber 5 to extend close to the forward end of the valve piston 8. An output rod 14 is interposed between the valve piston 8 and the master piston 13. The valve piston 8 transmits the output of the diaphragm 4 depending on the pressure difference between the constant pressure chamber 5 and the variable pressure chamber 6, to the output rod 14 through a reaction member 17 thereby to make the output rod 14 pressure the master piston 13 forward. A return spring 16 is interposed between the front shell 2 and the forward end surface of the valve piston 8 to urge the same rearward.

As shown in FIG. 2, a reaction force chamber hole 8c, a reaction force hole 8d opening to the reaction force chamber hole 8c and being smaller in diameter than the reaction force chamber hole 8c and a valve member receiving hole 8f being large in diameter are formed in series from the forward end surface toward the rear end surface of the valve piston 8 on the axis of the same. An annular recess 8n is axially formed in the reaction force chamber hole 8c, and an annular protrusion 14a formed at the rear end of the output rod 14 is inserted into the annular recess 8n axially slidably. Thus, a reaction force chamber 15 is defined between the annular protrusion 14a and a bottom surface of the base portion 8a, and the disc-like reaction member 17 made of an elastic material is received in the reaction force chamber 15.

Further, a numeral 21 designates a plunger whose forward end rod portion 21a is slidably received in the reaction force hole 8d. The forward end surface of the forward end rod portion 21a is in abutting engagement with the rear end surface of an abutting member 19, which is slidably received in the reaction force hole 8d. An atmosphere valve seat 21b is formed at the rear end surface of the plunger 21.

A numeral 22 denotes a key member taking the shape of “H” letter, which restricts the relative movement of the plunger 21 to the valve piston 8. Straight portions formed at the opposite sides of the key member 22 have their inner sides which partly get in an annular engaging groove 21c formed on the plunger 21 to be movable by a predetermined distance relative to the same in the forward-rearward direction. The straight portions of the key member 22 pass through two rectangular holes 8i, which are formed on radially opposite side walls of the valve piston 8 between the base portion 8a and the valve member receiving hole 8f, as they are guided at outer side surfaces thereof along the rectangular holes 8i, and extend both end portions radially outwardly of the valve piston 8. The dimension in thickness of the key member 22 is smaller than the dimension in the forward-rearward direction of the rectangular holes 8i, so that the key member 22 is also able to move relative to the valve piston 8 by a predetermined distance in the forward-rearward direction. Further, the key member 22 is contactable with the end surface of the protruding portion 3a of the rear shell 3 at opposite end portions thereof which protrude externally of the valve piston 8. Thus, the valve piston 8 and the plunger 21 are axially movable relative thereto by a distance which is determined by subtracting double the thickness of the key member 22 from the sum of the widths of the rectangular holes 8i and the engaging groove 21c.

The rear end of the plunger 21 is connected to an input rod 23 as the same is swingable. The input rod 23 passes through a filter element 24 for preventing dust or the like from going therethrough and a silencer 27 having a noise absorption function, extends rearward beyond the sliding cylindrical portion 8b and is connected to a brake pedal 25 (refer to FIG. 1). The plunger 21 and the input rod 23 constitute an input member 20 which is axially movable by the brake pedal 25.

A bellows 26 is secured between the input rod 23 and the protruding portion 3a of the rear shell 3 to cover the sliding cylindrical portion 8b of the valve piston 8. A plurality of vent holes 26a arranged on a circle are opened at the end surface of the bellows 26, and the atmospheric air is admitted through these vent holes 26a, the silencer 27 and the filter element 24 into the valve piston 8.

A valve mechanism 30 for making the variable pressure chamber 6 communicate selectively with the constant pressure chamber 5 and the atmosphere is provided with negative pressure valve seats 8k protruding from flat surfaces 8j which are formed at two diametrically opposed places in the valve member receiving hole 8f of the valve piston 8 each to take a curved, elongate circular shape. Each negative pressure valve sheet 8k is formed so that a ridge or ledge protrudes along the circumference of each ellipse which is curved or crooked along an arc having the center on the axis of the valve piston 8. Passages 8m surrounded by the negative pressure valve seats 8k pass through the side wall of the valve piston 8 to open to the constant pressure chamber 5.

At the rear end portion of the plunger 21, the atmosphere valve seat 21b is formed radially inside the negative pressure valve seats 8k. A disc-like valve member 31 is loosely received in the valve member receiving hole 8f to be movable in the forward-rearward direction. Formed at the forward end surface of the valve member 31 are negative pressure valves 31a, which are brought selectively into contact with or separation from the negative pressure valve seats 8k for bringing the variable pressure chamber 6 selectively into communication with the constant pressure chamber 5 or isolation from the same. The forward end surface of the valve member 31 annually protrudes an atmosphere valve 31b at a portion which is smaller in diameter than the negative pressure valves 31a. The atmosphere valve 31b is selectively brought into contact with or separation from the atmosphere valve seat 21b, so that the variable pressure chamber 6 is selectively blocked from the atmosphere or is made to communicate with the same.

The rear end of the valve member 31 is connected to an annular holder 35 by means of a bellows 35 enabling the valve member 31 to move in the axial direction. The holder 35 is pressured on a shoulder portion formed in the valve member receiving hole 8f by means of the resilient force of a compression spring 38 which is interposed between the holder 35 and a retainer 37 fixedly engaged on the axial mid portion of the input rod 23. Another compression spring 39 is interposed between the rear end surface of the valve member 31 and the retainer 37 to urge the valve member 31 forward relative to the input rod 23. Thus, in an ordinary state (i.e., the state of non-braking operation), the atmosphere valve 31b and the atmosphere valve seat 21b are made to contact with each other thereby to block the communication of the variable pressure chamber 6 with the atmosphere, and the negative pressure valve 31a is held at a position where it is slightly separated from the negative pressure valve seats 8k to make the variable pressure chamber 6 and the constant pressure chamber 5 communicate with each other.

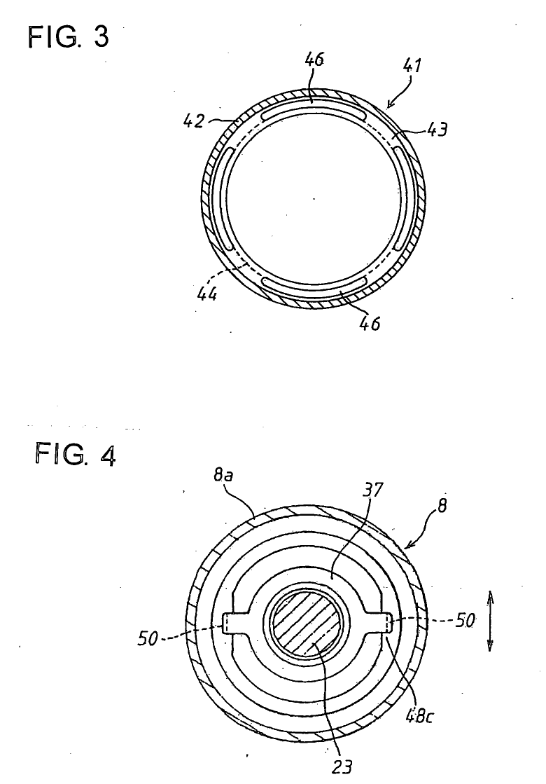

At the opening portion of the sliding cylindrical portion 8b of the valve piston 8, a cylindrical member 41 having a stepped portion at its intermediate portion is arranged between the internal surface of the sliding cylindrical portion 8b and the external surface of the silencer 27. A sleeve 42 fitted in the internal surface of the sliding cylindrical portion 8b is formed on the forward end side of the cylindrical member 41. The sleeve 42 is prevented from axial movement by being engaged with a protrusion 35a protruded from the holder 35 and is kept at a position to adjoin with the holder 35. As shown also in FIG. 3, a flange portion is protruded radially inwardly at the axial mid portion of the cylindrical member 41 to form the intermediate stepped portion 43 by the protrusion of the flange portion. An annular wall 44 is provided on the rear end side of the cylindrical member 41 to extend rearward in contact with the internal surface of the flange portion. The annular wall 44 is fitted on the external surfaces of the filter element 24 and the silencer 27. The external surface of the annular wall 44 is provided thereon with a plurality of ribs 44a, which are circumferentially arranged to contact with the internal surface of the sliding cylindrical portion 8b, and secondary passages 45 are constituted by the spaces between the ribs 44a to directly communicate with the atmosphere through the vent holes 26a.

A plurality of communication passages 46 each taking an arc shape are formed between the annular wall 44 and the intermediate stepped portion 43 and are always in communication with the secondary passages 45 through another filter element 47 provided between the external surface of the annular wall 44 and the internal surface of the sliding cylindrical portion 8b. Being smaller in air path resistance than the silencer 27, the filter element 47 is not only capable of admitting the atmospheric air easily, but also capable of reliably preventing dust or the like form entering.

A ring-like bypass valve member 48 is provided to face the intermediate stepped portion 43 and the forward end portion of the annular wall 44 and is composed of a seal member 48a at the rear surface and a back plate 48b at the forward surface. A compression spring 49 is interposed between the back plate 48b of the bypass valve member 48 and the holder 35 with itself being compressed, and thus, the seal member 48a of the bypass valve member 48 is ordinarily brought by the resilient force of the compression spring 49 into contact with the forward end portion of the intermediate stepped portion 43 to close the communication passages 46. With this configuration, the bypass valve member 48 constitutes closing means for closing the communication passages 46 in the ordinary state (the state of non-braking operation or the state of ordinary operation).

The retainer 37 has formed operating portions 50 protruding their distal ends forward, and the operating portions 50 are held to face the rear surface of the bypass valve member 48 with a predetermined clearance relative thereto in the state of non-braking operation or the state of ordinary operation. As shown in FIG. 4, the operating portions 50 are formed at the ends of radial portions of the retainer 37 which extend perpendicular to a swing motion direction (the arrowed direction in FIG. 4) of the input rod 23 given by the brake pedal 25. The bypass valve member 48 engageable with the operating portions 50 are provided with receiving portion 48c whose withes in the diametrical direction are narrowed, at two places in the circumferential direction. This makes it possible to enlarge the clearance between the bypass valve member 48 and the operating portions 50 in the swing motion direction of the input rod 23 resulting from the manipulation of the brake pedal 25, and thus, the operating portions 50 are enabled to bring the bypass valve member 48 into a release operation without interfering with the swing motion of the input rod 23.

The operation of the negative pressure type booster device as constructed above in the first embodiment will be described hereinafter. At the time of an ordinary operation of the brake pedal 25, the input rod 23 advances the plunger 21 against the resilient force of the compression spring 38, and the valve member 31 is advanced by the resilient force of the compression spring 39. This brings the negative pressure valves 31a respectively into contact with the negative pressure valve seats 8k thereby to block the communication between the variable pressure chamber 6 and the constant pressure chamber 5. As the plunger 21 is advanced further, the atmosphere valve seat 21b is separated from the atmosphere valve 31b, whereby the atmospheric air admitted into the valve piston 8 through the silencer 27 and the filter element 24 is flown into the variable pressure chamber 6 through the atmosphere valve 31b. Thus, a pressure difference is generated between the variable pressure chamber 6 and the constant pressure chamber 5, and the diaphragm 4, the plate 7 and the valve piston 8 are moved forward due to the pressure difference thereby to advance the output rod 14 through the reaction member 17. Accordingly, the master piston 13 is pushed forward by the output rod 14, so that pressurized brake oil is generated in the master cylinder 11 in dependence on the stepping force exerted on the brake pedal 25.

In the aforementioned ordinary operation of the brake pedal 25, the moving amount of the input rod 23 relative to the valve piston 8 is small, and it does not take place that the bypass valve member 48 is operated by the operating portions 50 of the retainer 37, so that the communication passages 46 remain in the closed state.

The valve piston 8 elastically deforms the reaction member 17 by the operating force which corresponds to the pressure difference between the both chambers 5, 6 acting on the diaphragm 4 and pushes the master piston 13 through the output rod 14. When elastically deformed, the reaction member 17 is partly flown into the reaction force hole 8d thereby to push the forward end portion of the forward end rod portion 21a of the plunger 21 rearward through the abutting member 19. Thus, the plunger 21 is retracted to make the atmosphere valve seat 21b take seat on the atmosphere valve 31b, whereby the communication of the variable pressure chamber 6 with the atmosphere is blocked to hold a desired pressure of the brake oil. During this operation, the force exerted on the brake pedal 25 is transmitted from the forward end rod portion 21a of the plunger 21 to the reaction member 17 through the input rod 23. Since the reaction member 17 is elastically deformed in dependence on the stepping force, the driver can feel a reaction force.

When the brake pedal 25 is released after the braking operation, the plunger 21 is moved by the resilient force of the compression spring 38 rearward relative to the valve piston 8. Thus, the atmosphere valve seat 21b is brought into contact with the atmosphere valve 31b to move the valve member 31 against the resilient force of the compression spring 39 rearward relative to the valve piston 8, whereby the negative pressure valves 31a are separated from the negative pressure valve seats 8k. As a result, the negative pressure in the constant pressure chamber 5 is led to the variable pressure chamber 6 by way of the passages 8m to make zero the pressure difference between the variable pressure chamber 6 and the constant pressure chamber 5. Therefore, the valve piston 8, the plate 7 and the diaphragm 4 are moved rearward by the resilient force of the return spring 16, and the master piston 13 is moved rearward with the result that no pressure of the brake oil is generated in the master cylinder 11.

The plunger 21 is stopped at the same time as the key member 22 is brought into contact with the stepped internal surface of the protruding portion 3a of the rear shell 3, while the valve piston 8 is stopped upon contact with the key member 22. Thus, while the brake is not applied, the negative pressure valves 31a remain very close to the negative pressure valve seats 8k, so that when the brake then begins to be applied, the negative pressure valves 31a can quickly come into contact with the negative pressure valve seats 8k as soon as the valve member 31 moves forward.

When the brake pedal 25 is stepped on strongly or sharply, on the contrary, the input rod 23 is advanced relative to the valve piston 8 through a longer distance than that it is done at the time of the ordinary braking. When the input rod 23 is advanced beyond a predetermined distance relative to the valve piston 8, the operating portions 50 of the retainer 37 push the bypass valve member 48 against the resilient force of the compression spring 49. Thus, the bypass valve member 48 is separated from the intermediate stepped portion 43 to open the communication passages 46. As a result, besides the atmospheric air which flows into the variable pressure chamber 6 through the silencer 27, the filter element 24 and the atmosphere valve 31b in the same manner as described above, the atmospheric air flows from the secondary passages 45 through the filter element 47, the communication passages 46 and the atmosphere valve 31b directly into the variable pressure chamber 6 without passing through the silencer 27. Accordingly, regardless of an air path resistance of the silencer 27, a sufficient volume of the atmospheric air is admitted into the variable pressure chamber 6 without delay, so that the responsiveness in the operation at the time of the shape braking operation can be heightened. Further, since the action force of the input rod 23 pressures the valve piston 8 through the compression spring 49, the valve piston 8 can be suppressed from vibrating at an early stage that the atmospheric air is admitted.

Further, since the operating portions 50 of the retainer 37 for operating the bypass valve member 48 extend in a direction perpendicular to the swing motion direction of the input rod 23 effected by the manipulation of the brake pedal 25 and are engageable with the bypass valve member 48 at the two points, the bypass valve member 48 can open the communication passages 46 stably without interfering with or obstructing the swing motion of the input rod 23 which would otherwise occur if the retainer 37 were brought into engagement with the bypass valve member 48 at the whole circumferential length thereof. In addition, since the spaces for the communication passages 46 in the vertical direction are made to be smaller, the valve piston 8 can be made to be small in diameter.

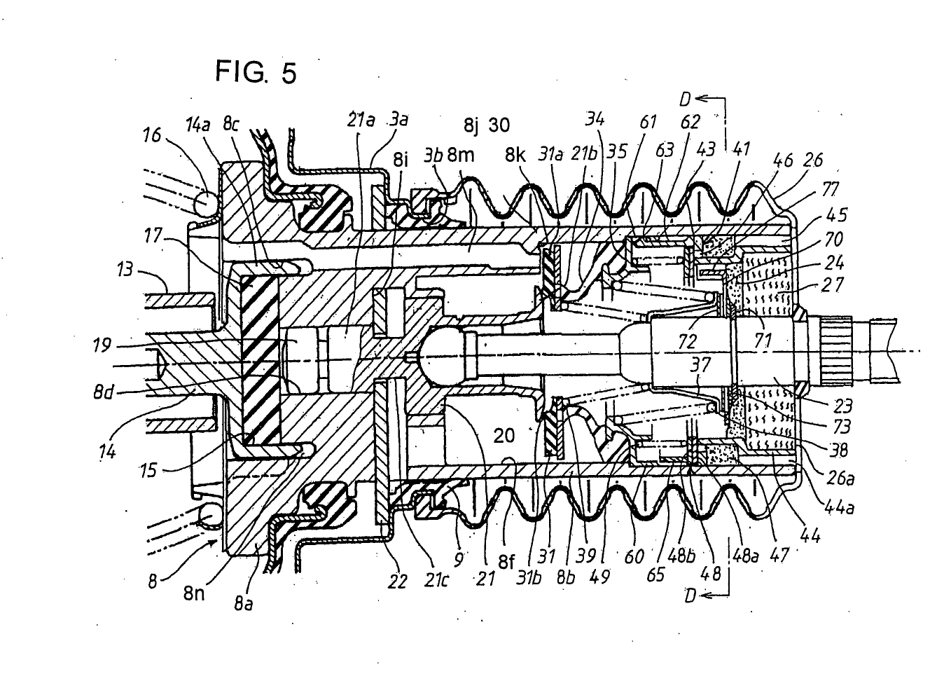

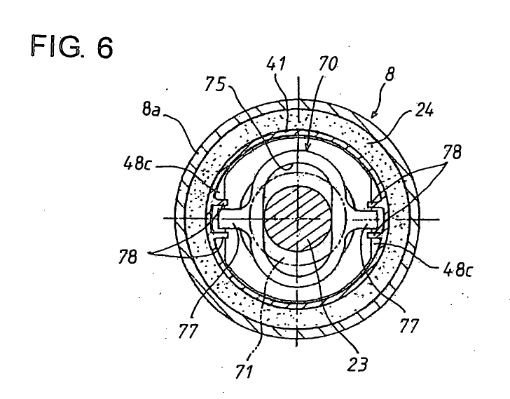

FIGS. 5 and 6 show the second embodiment according to the present invention, and the device in the second embodiment takes the configuration that enables the productivity to be further improved and the stability in operation to be further enhanced compared with the configuration of the device in the first embodiment. Therefore, the following description will be directed primary to the respects which differ from the first embodiment, and the same components as those in the first embodiment will be omitted from being described by being given the same reference numerals as given to those in the first embodiment.

In FIG. 5, the annular holder 35 having the bellows 34 secured thereto is pressured on the shoulder portion of the valve member receiving hole 8f by the resilient force of the compression spring 38 which is interposed between the annular holder 35 and the retainer 37 secured at the axial mid portion of the input rod 23, and is substantially prevented by the friction force from being rotated relative to the valve piston 8. The holder 35 has formed thereon a skirt portion 60 extending rearward, and engaging holes 61 are formed on the skirt portion 60 at, e.g., two places in the circumferential direction thereof.

At the opening portion of the sliding cylindrical portion 8b of the valve piston 8, the cylindrical member 41 having the intermediate stepped portion 43 is arranged between the internal surface of the sliding cylindrical portion 8b and the external surface of the silencer 27. Resiliently deformable portions 62 each given a resilient force radially outward are formed on the cylindrical member 41 to extend forward from the forward end surface. The resiliently deformable portions 62 are provided at their forward ends with hooks 63, which are engageable by the resilient forces respectively with the engaging holes 61 formed on the skirt portion 60 of the holder 35. With the engagements of the hooks 63 with the engaging holes 61, the cylindrical member 41 is restricted not to move in the circumferential direction as well as in the axial direction. Likewise in the first embodiment, the annular wall 44 is provided on the cylindrical member 41 to extend rearward and is fitted on the external surfaces of the filter element 24 and the silencer 27. The external surface of the annular wall 44 is provided thereon with the plurality of external ribs 44a, which are circumferentially arranged to contact with the internal surface of the cylindrical portion 8b, and the secondary passages 45 are constituted by the spaces between the external ribs 44a to directly communicate with the atmosphere through the vent holes 26a. Further, the communication passages 46 each taking the arc shape (refer to FIG. 3) are formed between the annular wall 44 and the intermediate stepped portion 43 and are always in communication with the secondary passages 45 through the filter element 47 provided between the external surface of the annular wall 44 and the internal surface of the sliding cylindrical portion 8b. Being smaller in the air path resistance than the silencer 27, the filter element 47 is not only capable of admitting the atmospheric air easily, but also capable of reliably preventing dust or the like form entering.

The ring-like bypass valve member 48 is provided to face the intermediate stepped portion 43 and the forward end portion of the annular wall 44 and is composed of the seal member 48a at the rear surface and the back plate 48b at the forward surface. The compression spring 49 is interposed between the back plate 48b of the bypass valve member 48 and the holder 35 with itself being compressed, and thus, the seal member 48a of the bypass valve member 48 is ordinarily brought by the resilient force of the compression spring 49 into contact with the forward end portion of the intermediate stepped portion 43 to close the communication passages 46. The bypass valve member 48 has the guided portion 65 extending forward, and the guided portion 65 is brought into fitting in the internal surface of the holder 35 to be guided slidably upon the advance movement of the bypass valve member 48. The movement of the bypass valve member 48 can be done smoothly by the slide guiding operation of the skirt portion 60 for the guided portion 65.

An operating member 70 for operating the bypass valve member 48 is provided as a member independent of the retainer 37 fixedly engaged on the axial mid portion of the input rod 23. The operating member 70 is interposed between a snap ring 71 fixedly engaged on the input rod 23 and the rear surface of the retainer 37. A waved washer 72 is interposed between the operating member 70 and the rear surface of the retainer 37. The operating member 70 is brought by the resilient force of the waved washer 72 into contact with the snap ring 71 through a spacer 73 so that the rear end position thereof is restrained. As shown in FIG. 6, the operating member 70 has a guide aperture 75 formed therein and taking an elliptical form which is slender to elongate in the swing motion direction (the vertical direction as viewed in FIG. 6) of the input rod 23 effected by the brake pedal 25 and which has approximately the same dimension in the left-right direction as that of the input rod 23. By the provision of the guide aperture 75, the input rod 23 is allowed to swing, but is restrained not to move in the direction perpendicular to the swing motion direction.

Further, operating portions 77 protruding distal ends thereof forward are formed on the operating member 70 and remain to face the rear surface of the bypass valve member 48 with a predetermined clearance therebetween at the time of the non-braking operation or the ordinary braking operation. As shown in FIG. 6, the operating portions 77 extend in the direction perpendicular to the swing motion direction of the input rod 23, and the outer ends of the operating portions 77 are bent and oriented toward the rear surface of the bypass valve member 48 to face the rear surface of the bypass valve member 48. The receiving portions 48c whose each width in the diametrical direction is narrowed are formed at two places in the circumference direction of the internal surface of the bypass valve member 48, and the bent outer ends of the operating portions 77 are respectively engageable with the receiving portions 48c. A pair of inner ribs 78 for circumferentially sandwiching the outer end of each operating portion 77 therebetween from opposite sides with a clearance are formed at each of the two places in the circumference direction of the internal surface of the cylindrical member 41. The pairs of the inner ribs 75 constitute a position restraining portion which axially slidably guides the operating member 70 relative to the cylindrical member 41, but restrains the position of the operating member 70 in the circumferential direction. Accordingly, although the compression spring 49 applies a rotational moment to the operating member 70, the same can be prevented from moving in the circumferential direction, so that it becomes possible to keep the swing motion of the input rod 23 stably.

In this manner, the operating member 70 is prevented by the cylindrical member 41 from being rotated relative to the holder 35, whereas the holder 35 is substantially prevented by the friction force from being rotated relative to the valve piston 8. Thus, the operating member 70 is assembled with itself being positioned relative to the valve piston 8 in the circumferential direction.

In the foregoing second embodiment, like the negative pressure type booster device in the prior art, the valve piston 8 has assembled therein basic components of a conventional negative pressure type booster device such as the negative pressure valves 31a, the atmospheric valve 31b, the input rod 23, the holder 35, the retainer 37, the compression springs 38, 39 and the like.

Then, the cylindrical member 41 with the filter element 47 fitted thereon is inserted to a predetermined position in the valve piston 8 as the bypass valve member 48 with the compression spring 49 interposed is engaged with the intermediate stepped portion 43 of the cylindrical member 41. Thus, the hooks 63 of the cylindrical member 41 are dropped by their resilient forces respectively into the engaging holes 61 of the holder 35, and the cylindrical member 41 is positioned in the circumferential direction as well as in the axial direction. Thereafter, the waved washer 72, the operating member 70, the spacer 73 and the snap ring 71 are in turn fitted on and attached to the input rod 23, whereby the rear end position of the operating member 70 is restrained by the snap ring 71. At this time, the operating member 70 is assembled to insert each of the operating portions 77 into the space between a corresponding pair of the inner ribs (position restraining portion) 78 of the cylindrical member 41 and therefore, is positioned at an angular position where it allows the input rod 23 to be swung by the brake pedal 25. Finally, the filter element 24 and the silencer 27 are fitted into the internal surface of the cylindrical member 41.

In the foregoing second embodiment, when the brake pedal 25 is stepped on strongly or sharply, the input rod 23 is advanced relative to the valve piston 8 through a longer distance than that it is done at the time of the ordinary braking operation, and thus, the bypass valve member 48 is separated from the intermediate stepped portion 43 to open the communication passages 46. As a result, the atmospheric air flows from the secondary passages 45 through the filter element 47, the communication passages 46 and the atmosphere valve 31b directly into the variable pressure chamber 6 without passing through the silencer 27. Accordingly, in the same manner as the foregoing first embodiment, a sufficient volume of the atmospheric air is led without delay into the variable pressure chamber 6 regardless of the air path resistance of the silencer 27, so that the responsiveness in the operation at the time of the shape braking operation can be heightened.

Further, since by the inner ribs (position restraining portion) 78 provided on the cylindrical member 41 which is positioned relative to the valve piston 8 in the circumferential direction, the operating member 70 is prevented from rotating in the circumferential direction, the input rod 23 can be allowed to be swung reliably and stably upon the manipulation of the brake pedal 25. Therefore, the opening and closing operations of the negative pressure valves 31a and the atmosphere valve 31b can be performed stably over a long period of time, so that it can be realized to maintain the braking performance stable. In addition, because the high-responsive components can be assembled in turn after assembling the basic components of the negative pressure type booster device, it can be realized to enhance the productivity greatly. Since it becomes easier to select the specifications of whether the negative pressure type booster devices to be manufactured are those with an ordinary function or those with a high responsive function, the coping with a change in the production can be done speedily and easily.

In the first and second embodiments, the cylindrical member 41 is positioned relative to the valve piston 8 in the circumferential direction by engaging the cylindrical member 41 with the holder 35 which is substantially prevented by the friction force from rotating relative to the valve piston 8. However, the cylindrical member 41 may be directly engaged with the valve piston 8 to be prevented from rotating, by providing an engaging groove on the internal surface of the valve piston 8 and by engaging a protrusion formed on the external surface of the cylindrical member 41 with the engaging groove.

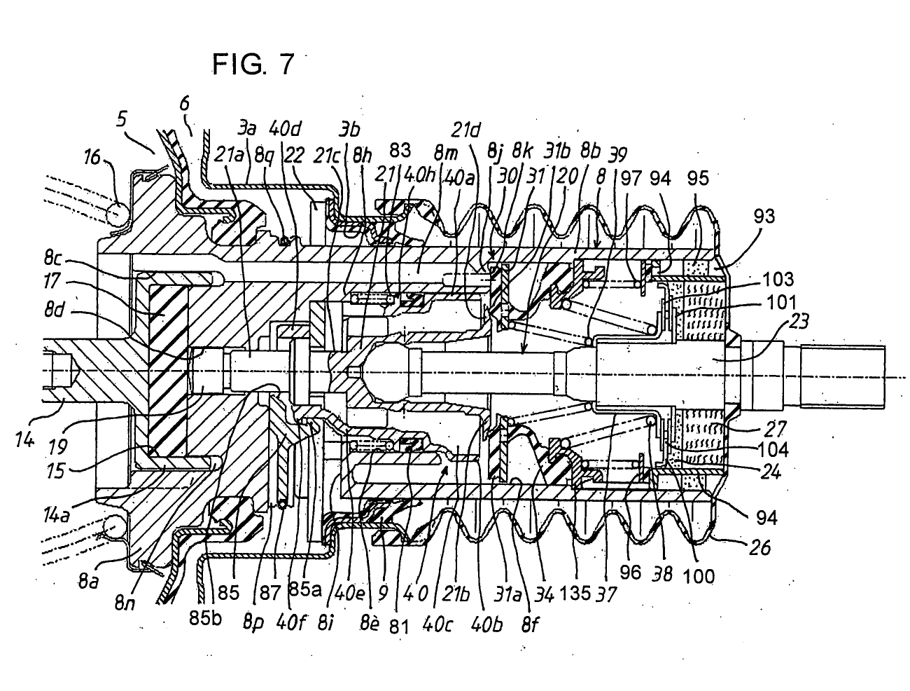

FIGS. 7 through 11 show the third embodiment according to the present invention, and the differences of this embodiment from the first embodiment reside in that the foregoing negative pressure type booster device is given an emergency braking function in which a larger brake force than that at the time of the ordinary braking can be output at the time of the emergency braking by changing the jumping property thereof and that the foregoing negative pressure type booster device is slightly modified as to the construction for opening the secondary passages when the input rod 23 is advanced beyond the predetermined distance relative to the valve piston 8. Therefore, the following description will be directed primary to the respects which differ from the first and second embodiments, and the same components as those in the embodiments will be omitted from being described by being given the same reference numerals as given to those in the embodiments.

As shown in FIG. 7, the reaction force chamber hole 8c, the reaction force hole 8d opening to the reaction force chamber hole 8c and being smaller in diameter than the reaction force chamber hole 8c, the plunger receiving hole 8e and the valve member receiving hole 8f being large in diameter than the plunger receiving hole 8e are formed in series from the forward end surface toward the rear end surface of the valve piston 8 on the axis of the same.

The H-letter shape key member 22 is slidably engaged at outside surfaces of both straight portions thereof with rectangular holes 8i which are formed radially between the base end portion 8a and the plunger receiving hole 8e, and extends opposite end portions thereof externally of the valve piston 8.

The flat surfaces 8j each taking a curved, elongate circular shape, of the valve mechanism 30 for making the variable pressure chamber 6 communicate selectively with the constant pressure chamber 5 and the atmosphere are defined by a sectional portion of the valve member receiving hole 8f of the valve piston 8 and a rearward extension portion of the plunger receiving hole 8e. The two negative pressure valve seats 8k protrude from the two flat surfaces 8j of the curved, elongate circular shape to be symmetrical with respect to the axis.

The disc-like valve member 31 which is loosely received in the valve member receiving hole 8f to be movable in the forward-rearward direction has formed at the forward end surface thereof first negative pressure valves 31a (the negative pressure valves 31a in the first embodiment) which are brought into contact with or separation from first negative pressure valve seats 8k (the negative pressure valve seats 8k in the first embodiment) to make the variable pressure chamber 6 communicate with or blocked from the constant pressure chamber 5. The forward end surface of the valve member 31 annually protrudes the atmosphere valve 31b at a portion which is smaller in diameter than the first negative pressure valves 31a. The atmosphere valve 31b is selectively brought into contact with or separation from the atmosphere valve seat 21b, so that the variable pressure chamber 6 is selectively made to communicate with, or blocked from the atmosphere.

A numeral 40 denotes a valve seat member surrounding the plunger 21, and the rearward cylindrical portion 40a of the valve seat member 40 is axially slidably fitted in the internal surface of the plunger receiving hole 8e of the valve piston 8 with a seal element 81 air-tightly provided therebetween. The cylindrical portion 40a of the valve seat member 40 is provided at its rear end with second negative pressure valve seats 40b surrounding the atmosphere valve seat 21b, and in the ordinary state, the second negative pressure valve seats 40b are positioned slightly ahead of the first negative pressure valve seats 8k so that they do not contact with the valve member 31. The rear end of the cylindrical portion 40a of the valve seat member 40 is partly expanded in the radial direction at positions each of which is circumferentially different from the first negative pressure valve seats 8k, that is, circumferentially between the two first negative pressure valve seats 8k, and the second negative pressure valve seats 40b define main air leading portions 40c at the expanded portions thereof. A compression spring 83 for urging the valve seat member 40 rearward is interposed between an annular protrusion 40h which is protruded at the outer surface of the cylindrical portion 40a of the valve seat member 40 and an annular stepped portion 8h which is formed on the internal surface of the plunger receiving hole 8e.

The valve seat member 40 is provided at its forward end portion with an annular engaging portion 40d which is slidably fitted on a large diameter portion formed on the forward end rod portion 21a of the plunger 21. The engaging portion 40d and the cylindrical portion 40a are joined by two linking portions 40e. At the radial opposite sides of the forward end rod portion 21a, the two linking portions 40e are put between the both straight portions of the key member 22 taking the shape of “H” letter and is prevented from coming off in such a manner that a cross beam portion of the key member 22 is kept contacted with the outer surface of one of the liking portions 40e while engaging portions formed inner sides of the both straight portions are kept engaged with the outer surface of the other liking portion 40e. Thus, the valve seat member 40 is prevented by the key member 22 from rotation, so that the pair of air leading portions 40c are held at the same angular phase as the key member 22 to be located between the two first negative pressure valve seats 8k in the circumferential direction. The two liking portions 40e pass through cutouts formed on the annular stepped portion 8h and communication grooves to extend from the plunger receiving hole 8e to the rectangular holes 8i. The communication grooves are axially formed at a fitting portion of the plunger 21 which is fitted in the annular stepped portion 8h.

Within the valve piston 8, latch member receiving grooves 8p forming two radially opposed flat surfaces are formed ahead of the rectangular holes 8i at two places in the circumferential direction, and latch members 85 are held within the latch member receiving grooves 8p to be movable radially. The latch members 85 are provided with claw potion 85a, which are engageable with engaging protrusions 40f formed at the forward end of the valve seat member 40, respectively. By the engagements of the latch members 85 with the valve seat member 40, the valve seat member 40 is held to take such an ordinary position thereof that the second negative pressure valve seats 40b separate forward from the valve member 31, against the resilient force of the compression spring 83. A garter spring 87 received in an annular groove 8q formed on the valve piston 8 is engaged with the radial outer ends of the latch members 85, so that the latch members 85 are urged by the garter spring 87 toward the radial inward direction to make the claw portions 85a engage respectively with the engaging protrusions 40f.

A cam surface 85b is formed on the inner surface of each latch member 85. When the plunger 21 is moved forward beyond the predetermined distance relative to the valve piston 8, the plunger 21 is pressured on the cam surfaces 85b to push the latch members 85 radially outward against the urging force of the garter spring 87, so that the claw portions 85a can be disengaged from the engaging protrusions 40f.

The valve seat member 40 disengaged from the latch members 85 is again brought into the engagements to be held at the ordinary position when the valve seat member 40 is advanced relative to the valve piston 8 in the state that the plunger 21 has not been moved forward beyond the predetermined distance relative to the valve piston 8. When the valve piston 8 is moved rearward by the resilient force of the return spring 16 after the key member 22 is brought into abutting engagement with the stepped inner surface of the protruding portion 3a of the rear shell 3 with the rear end of the engaging portion 40d of the valve seat member 40 being in abutting contact on the key member 22, the valve seat member 40 is moved forward relative to the valve piston 8 to bring the forward end surface of each engaging protrusion 40f into engagement with the rear end of each claw portion 85a. Thus, the engaging protrusions 40f get through the claw portions 85a as they forcibly open the claw portions 85a against the resilient force of the garter spring 87, whereby the engaging protrusions 40f are again brought into engagements with the claw portions 85a to hold the valve seat member 40 at the ordinary position.

At the opening portion of the sliding cylindrical portion 8b of the valve piston 8, a cylindrical member 91 having an intermediate stepped portion 91a is arranged between the internal surface of the sliding cylindrical portion 8b and the external surfaces of the filter element 24 and the silencer 27. Resiliently deformable portions 91b each given a resilient force in the radial inward direction are formed at the forward end portion of the cylindrical member 91 at plural places in the circumferential direction. The resilient deformable portions 91b are provided at the forward ends thereof with hooks 91c, which are engaged with an annular engaging groove 135a formed on a holder 135. The holder 135 is pressured by the resilient force of the compression spring 38 on the shoulder portion of the valve member receiving hole 8f. Thus, by the engagements of the hooks 91c with the engaging groove 135a, the cylindrical member 91 is prevented from moving relative to the holder 135 in the axial direction.

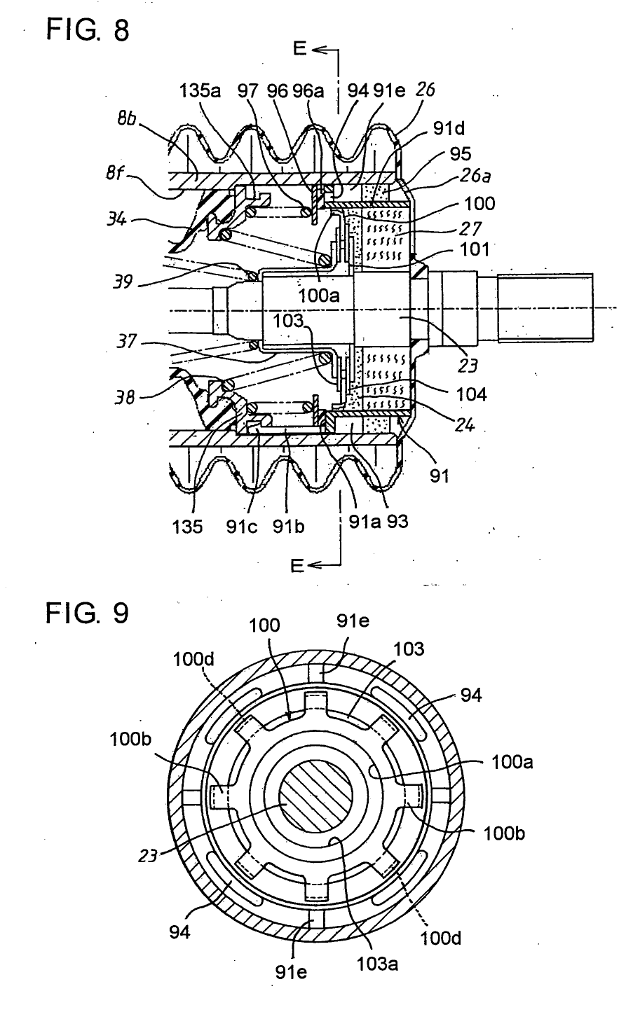

Also shown in FIG. 8, a flange portion extends radially inward from an intermediate stepped portion 91a of the cylindrical member 91. The annular intermediate stepped portion 91a is formed by protruding the flange portion. The cylindrical member 91 is provided on its rear end side with an annular wall 91d which extends rearward in connection with the internal surface of the flange portion, and the annular wall 91d is fitted on the external surfaces of the filter element 24 and the silencer 27. The external surface of the annular wall 91d is provided thereon with a plurality of ribs 91e, which are circumferentially arranged to contact with the internal surface of the sliding cylindrical portion 8b, and secondary passages 93 are constituted by the spaces between these ribs 91e to communicate directly with the atmosphere through the vent holes 26a.

As shown in FIG. 9, communication passages 94 each taking an arc shape are formed between the annular wall 91d and the annular stepped portion 91a and are always in communication with the secondary passages 93 through another filter element 95 provided between the external surface of the annular wall 91d and the internal surface of the sliding cylindrical portion 8b. Being smaller in air path resistance than the silencer 27, the filter element 95 is not only capable of admitting the atmospheric air easily, but also capable of reliably preventing dust or the like form entering.

A ring-like bypass valve member 96 is provided to face the forward end portion of the intermediate stepped portion 91a, and a seal member 96a is provided on the rear surface of the bypass valve member 96. A compression spring 97 is interposed between the bypass valve member 96 and the holder 135 with itself being compressed, and thus, the seal member 96a of the bypass valve member 96 is ordinarily brought by the resilient force of the compression spring 97 into contact with the forward end portion of the intermediate stepped portion 91a to close the communication passages 94. With this configuration, the bypass valve member 96 closes the communication passages 94 in the ordinary state (the state of non-braking operation or the state of ordinary operation).

An operating member 100 for operating the bypass valve member 96 is interposed between a snap ring 101 fixedly engaged on the input rod 23 and the rear surface of the retainer 37. A pair of washers 103, 104 constituting slide guiding members are provided to be radially movable between the snap ring 101 and the retainer 37, and the operating member 100 is arranged between the pair of washers 103, 104. By the resilient force of the compression spring 38 interposed between the retainer 37 and the holder 135, the operating member 100 is held ordinarily at a position where it is in contact with the snap ring 101 through the washers 103, 104, so that the rear end position thereof is restrained.

The operating member 100 has a large round inner hole 100a formed at center portion thereof which does not interfere with the input rod 23 even during the swing motion of the same, and the input rod 23 passes through the inner hole 100a. Therefore, even where assembled in an arbitrary angular phase, the operating member 100 is able to allow the swing motion of the input rod 23 effected by the brake pedal 25.

As shown in FIG. 9, the operating member 100 has the round inner hole 100a at the center portion thereof and takes the shape protruding a plurality of slide guided portions 100b from the circumference thereof in radial directions. The operating member 100 is received within the annular wall 91d of the cylindrical member 91 with a slight clearance in radial directions and is substantially hardly movable in the radial directions.

On the other hands, the pair of washers 103,104 have inner holes 103a which are smaller than the inner hole 100a of the operating member 100 but sufficiently larger than the outer diameter of the input rod 23 and are formed to be sufficiently smaller in outer diameters than the inner diameter of the annular wall 91d, so that they are movable in any radial direction with the swing motion of the input rod 23. Respective opposite end surfaces of the pair of washers 103, 104 constitute slide guiding portions which perform slide guiding relatively in radial directions between themselves and the operating member 100 and between themselves and the retainer 37 and the snap ring 101. Then, the slide guiding portions are set to the relation that with the swing motion of the input rod 23, the pair of washers 103, 104 are radially moved while being relatively slidden between the retainer 37, the snap ring 101 and the operating member 100 and that even when the pair of washers 103, 104 are moved their maximum amounts, the mutual slide guiding operations are kept between the retainer 37, the snap ring 101 and the operating member 100.

Thus, when the input rod 23 (input member 20) is swung by the manipulation of the brake pedal 25, the operating member 100 can always be retained stably at the center portions within the annular wall 91d of the cylindrical member 91 to keep the positional relation between the operating member 100 and the bypass valve member 96 invariable.

Outer ends of the slide guided portions 100b of the operating member 100 are bent forward to form operating portions 100d, and these operating portions 100d face the rear surface of the bypass valve member 96 with a predetermined clearance at the time of the non-braking operation or the ordinary braking operation. The operating portions 100d of the operating member 100 are brought into contact with the inner portion end surface of the bypass valve member 96 to push the bypass valve member 96 against the resilient force of the compression spring 97 when the input member 20 is advanced beyond the predetermined distance relative to the valve piston 8.

The operation of the negative pressure type booster device in the foregoing third embodiment will be described hereinafter. At the time of an ordinary operation of the brake pedal 25, the input rod 23 and the plunger 21 are advanced by the stepping of the brake pedal 25 against the resilient force of the compression spring 38, and the valve member 31 is advanced by the resilient force of the compression spring 39. This brings the first negative pressure valves 31a respectively into contact with the first negative pressure valve seats 8k thereby to block the communication between the variable pressure chamber 6 and the constant pressure chamber 5. As the plunger 21 is advanced further, the atmosphere valve seat 21b is separated from the atmosphere valve 31b, whereby the atmospheric air admitted into the valve piston 8 through the silencer 27 and the filter element 24 is flown into the variable pressure chamber 6 through the atmosphere valve 31b.

Thus, a pressure difference is generated between the variable pressure chamber 6 and the constant pressure chamber 5, and the diaphragm 4, the plate 7 and the valve piston 8 are moved forward due to the pressure difference thereby to advance the output rod 14 through the reaction member 17. Accordingly, the master piston 13 is pushed forward by the output rod 14, so that pressurized brake oil is generated in the master cylinder 11 in dependence on the stepping force exerted on the brake pedal 25.

In the aforementioned ordinary operation of the brake pedal 25, the moving amount of the input rod 23 relative to the valve piston 8 is small, and it does not take place that the bypass valve member 96 is operated by the operating portions 100b of the operating member 100, so that the communication passages 94 remain blocked. Further, the valve seat member 40 and the latch members 85 remain in the engaged state shown in FIG. 7, and the second negative pressure valve seats 40b remain separated from the valve member 31.

When the brake pedal 25 is stepped on strongly or sharply, the input rod 23 is advanced relative to the valve piston 8 through a longer distance than that it is done at the time of the ordinary braking. When the input rod 23 is advanced beyond a predetermined distance relative to the valve piston 8, the operating portions 100b of the operating member 100 push the inner portion end surface of the bypass valve member 96 against the resilient force of the compression spring 97. Thus, the bypass valve member 96 is separated from the intermediate stepped portion 91a to open the communication passages 94. As a result, besides the atmospheric air which flows into the variable pressure chamber 6 through the silencer 27, the filter element 24 and the atmosphere valve 31b in the same manner as described above, the atmospheric air which does not pass through the silencer 27 is admitted from the secondary passages 93 through the filter element 95, the communication passages 94 and the atmosphere valve 31b directly into the variable pressure chamber 6.

Accordingly, when the brake pedal 25 is stepped on strongly or sharply, a sufficient volume of the atmospheric air is admitted without delay into the variable pressure chamber 6 through the secondary passages 93 within the valve piston 8, so that it can be realized to enhance the responsiveness in operation at the time of the sharp braking. In addition, since the operating force of the input rod 23 pressures the valve piston 8 through the compression spring 97, it can be realized to suppress the valve piston 8 from vibrating at an early stage that the atmospheric air is admitted.

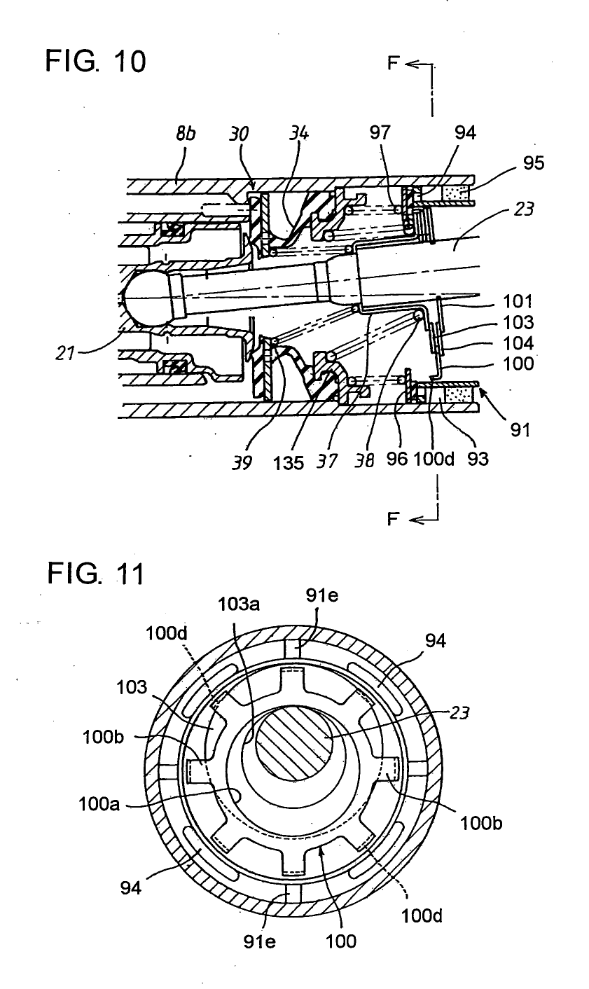

At this time, the manipulation of the brake pedal 25 causes the input rod 23 to swing as shown in FIG. 10. However, since the operating member 100 has the round inner hole 100a which does not interfere with the input rod 23 during the swing motion of the same, the assembling of the operating member 100 in an arbitrary angular phase does not result in obstructing the swing motion of the input rod 23, so that the input rod 23 can be allowed to swing surely and stably.

With the swing motion of the input rod 23, the retainer 37 and the snap ring 101 are radially slidden relative to the washers 103, 104. When the swing motion angle of the input rod 23 exceeds a predetermined angle, the input rod 23 comes into engagements with the inner holes 103a of the washers 103, 104, whereby the washers 103, 1034 are radially moved by the input rod 23 as being radially slidden relative to the operating member 100.

Therefore, during the swing motion of the input rod 23, the operating member 100 can be kept retained surely between the pair of washers 103, 104 and can be retained at the center position within the cylindrical member 91. Consequently, because it becomes unnecessary to take the assembling position of the operating member 100 into consideration, it can be realized to simplify the construction, to allow the swing motion of the input member 20 surely and stably and to control the opening and closing motions of the first negative pressure valves 31a and the atmosphere valve 31b over a long period of time.

Next, description will be made regarding the operation at the time of an emergency braking wherein the driver steps the brake pedal 25 quickly. The emergency braking property can be accomplished by varying the jumping property so that a larger propelling force than that at the time of the ordinary braking is exerted on the output member 14. In order to vary the jumping property, it can be done to take a larger clearance between the abutting member 19 and the reaction member 17. That is, by shifting the atmosphere valve 31b rearward, the clearance can be enlarged to increase the output power which is applied until the abutting member 19 comes to receive the reaction force from the reaction member 17. Thus, the output power in a so-called jumping state wherein the ratio of the output power to the input power becomes infinity is made to be larger than that in the ordinary state.

The jumping property in which the ratio of the output power to the input power becomes infinity is determined in dependence upon a distance through which the plunger 21 is advanced from the time that the atmosphere valve seat 21b begins to separate from the atmosphere valve 31b with the first negative pressure valves 31a being in contact with the first negative valve seats 8k, by the time that the abutting member 19 is brought into contact with the reaction member 17. At the time of emergency braking, because the second negative valve seats 40b are brought into contact with second negative pressure valves 31c formed on the valve member 31 to move the valve member 31 rearward, the distance through which the plunger 21 is advanced from the time that the atmosphere valve seat 21b begins to separate from the atmosphere valve 31b by the time that the abutting member 19 comes to contact with the reaction member 17 becomes longer than that at the time of the ordinary braking, and the distance by which the atmosphere valve seat 21b is separated from the atmosphere valve 31b during the same period of time becomes long. Thus, the variable pressure chamber 6 is caused to communicate with the atmosphere compulsorily and quickly, whereby a larger propelling force than that at the time of the ordinary braking is outputted to the output member 14 to heighten the jumping property.

As described earlier, at the time of the emergency braking wherein the driver steps the brake pedal 25 quickly, the plunger 21 is advanced beyond the predetermined distance relative to the valve piston 8. Thus, the large diameter portion of the forward end rod portion 21a of the plunger 21 pushes the cam surfaces 85b of the latch members 85. As a result, the latch members 85 are pushed against the resilient force of the garter spring 87 to make the claw portions 85a disengaged from the engaging protrusions 40f, and hence, the valve seat member 40 is released from the latch members 85. This allows the valve seat member 40 to be retracted by means of the resilient force of the compression spring 83 by the predetermined amount rearward relative to the valve piston 8, and the second negative pressure valve seats 40b are brought into contact with the valve member 31 to retract the same, whereby the atmosphere valve 31b is separated from the atmosphere valve seat 21b. The retraction of the valve seat member 40 relative to the valve piston 8 is restricted when the rear end of the engaging portion 40d comes into engagement with the key member 22 remaining in contact with the rear end surfaces of the rectangular holes 8i. Thus, the variable pressure chamber 6 is caused to communicate with the atmosphere compulsorily and quickly, whereby the larger propelling force than that at the time of the ordinary braking is outputted to the output member 14 with the result that a higher pressure is delivered from the master cylinder. With the increase of the output power, the reaction member 17 partly flows into the reaction force hole 8d to push the plunger 21 back through the abutting member 19. Thus, the atmosphere valve seat 21b is brought into contact with the atmosphere valve 31b to block the inflow of the atmospheric air, whereby the output power at the time of the emergency braking can be determined.

At the time of the emergency braking, as mentioned earlier, the atmospheric air is admitted into the valve piston 8 without passing through the silencer 27 and without delay, so that a large braking force at the time of the emergency braking can be outputted with a high responsiveness.

In the foregoing third embodiment, since the operating member 100 on the input member 20 for making the bypass valve member 96 open has the round inner hole 100a which does not interfere with the input member 20 during the swing motion of the same, the swing motion of the input member 20 by the manipulation of the brake pedal 25 can be allowed surely and stably without taking the assembling position of the operating member 100 into consideration. Accordingly, it becomes possible to control the opening and closing operations of the first negative pressure valves 31a and the atmosphere valve 31b stably over a long period of time, so that the braking performance can be maintained stably.

Although in the foregoing third embodiment, description has been made taking the example that the plurality of slide guided portions 100b are formed to extend radially from the circumference of the operating member 100 in order to secure the air passages into the valve piston 8, the operating member 100 may be constituted to take a disc-like shape wherein the air passages may be made by forming a plurality of holes to pass through the disc on a circle.

Further, the pair of washers 103, 104 which constitute the slide guiding members in the third embodiment may take the shape which for securement of the air passages, has a plurality of slide guiding portions extending radially like the operating member 100.

Finally, various features and many of the attendant advantages in the foregoing embodiments will be summarized as follows:

In each of the foregoing first to third embodiments typically shown in FIGS. 2, 5 and 7 for example, the secondary passages 45, 93 communicating directly with the atmosphere are formed between the internal surface of the sliding cylindrical portion 8b of the valve piston 8 and the external surface of the silencer 27, and the atmospheric air can be admitted from the secondary passages 45, 93 to the variable pressure chamber 6 when the input rod 23 is advanced relative to the valve piston 8 beyond the predetermined distance. Thus, when the brake pedal 25 is stepped on strongly or sharply, it can be realized to admit the atmospheric air from the secondary passages 45, 93 without passing through the silencer 27 and hence, to enhance the responsiveness. In addition, since the secondary passages 45, 93 are formed inside the internal surface of the valve piston 8, the negative pressure type booster device can be made compact in construction, and the smooth operation can be ensured.

In each of the foregoing first to third embodiments typically shown in FIGS. 2, 5 and 7, the communication passages 46, 94 defined by the cylindrical member 41, 91 having the stepped portion 43, 91a at the intermediate portion thereof are closed by the closing means 48, 96, 49, 97 to be blocked from the communication with the atmosphere valve seat 21b in the ordinary state, but is opened to make the secondary passages 45, 93 communicate with the atmosphere valve seat 21b when the input rod 23 is advanced relative to the valve piston 8 beyond the predetermined distance. Thus, even when the brake pedal 25 is stepped on strongly or sharply, it becomes possible to admit the atmospheric air to the variable pressure chamber 6 through the existing atmosphere valve 31b. Accordingly, it can be realized to enhance the responsiveness by adding a simple construction only to the prior art negative pressure type booster device and to heighten the reliability as the product.

In each of the foregoing first to third embodiments typically shown in FIGS. 2, 5 and 7, the closing means is composed of the bypass valve member 48, 96 for closing the communication passages 46, 94 upon contact with the intermediate stepped portion 43, 91a and the urging member 49, 97 for urging the bypass valve member 48, 96 in the direction toward contact with the intermediate stepped portion 43, 91a, and the operating portions 50, 77, 100d extending from the input rod 23 operate to push the bypass valve member 48, 96 forward against the urging member 49, 97 thereby to open the communication passages 46, 94. Thus, when the input rod 23 is advanced relative to the valve piston 8 beyond the predetermined distance, it becomes possible to make the operating portions 50, 77, 100d open the communication passages 46, 94 reliably and stably. Further, when the brake pedal 25 is stepped on strongly and sharply, the input rod 23 applies its action force to the valve piston 8, so that it can be realized to suppress the early stage vibration.

In each of the first and second embodiments typically shown in FIGS. 2 and 5, since the operating portions 50, 77 extending from the input rod 23 extend in a radial direction perpendicular to the swing motion direction of the input rod 23 by the brake pedal 25, the bypass valve member 48 can open the communication passages 46 accurately without being influenced by the swing motion of the input rod 23 in the vertical direction. Further, the space in the vertical direction for the communication passages 46 can be made to be compact, and hence, the valve piston 8 can be made to be small in diameter.

In the second embodiment shown in FIGS. 5 and 6, the cylindrical member 41 is positioned relative to the valve piston 8 in the circumferential direction, the operating member 70 is provided extending the operating portions 77, the position restraining portions 78 are provided for restraining the position of the operating member 70 relative to the cylindrical member 41 in the circumferential direction, and the operating member 70 has the guide aperture 75 which allows the swing motion of the input rod 23 but restrains the relative movement of the input rod 23 in the direction perpendicular to the swing motion direction. Thus, the swing motion of the input rod 23 can be allowed reliably and stably, so that it becomes possible to perform the opening and closing motions of the negative pressure valves 31a and the atmosphere valve 31b stably over a long period of time.

In each of the foregoing first to third embodiments typically shown in FIGS. 2, 5 and 7, after the input rod 23, the plunger 21 and the negative pressure valves 31a, the atmosphere valve 31b and the like are assembled into the valve piston 8, the operating member 37, 70, 100 is attached to the input rod 23 to have its rearward position restricted relative to the input rod 23. Thus, it can be realized to assemble the high responsive components in turn after the assembling of the basic components of the negative pressure type booster device, and hence, it can be realized to heighten the productivity greatly.

In the third embodiment typically shown in FIGS. 7 and 9, since the operating member 100 provided coaxially with the input rod 23 for opening the bypass valve member 96 to open has the round inner aperture 100a which does not interfere with the input rod 23 during the swing motion of the same, the operating member 100 can be attached in an arbitrary angular phase, and thus, it is unnecessary to take the assembling position of the operating member 100 into account. Therefore, because the construction can be simplified and because the swing motion of the input rod 23 can be allowed reliably and stably, it becomes possible to perform the opening and closing motions of the negative pressure valves 31a and the atmosphere valve 31b stably over a long period of time.

In the third embodiment typically shown in FIGS. 7 and 9, since the operating member 100 for operating the bypass valve member 96 is received with the slight clearance in radial directions in the cylindrical member 91 which is inserted into the internal surface of the sliding cylindrical portion 8b of the valve piston 8, the operating member 100 can be kept at the center position in the cylindrical member 91 regardless of the swing motion of the input rod 23, so that the opening operation by the operating member 100 of the bypass valve member 96 can be performed stably.

In the third embodiment typically shown in FIGS. 7 and 9, since the operating member 100 radially protrudes the plurality of slide guiding portions 100b arranged in the circumferential direction and defines the atmospheric air passages between the respective slide guiding portions 100b, the atmospheric air passages can be secured in spite of the fact that the operating member 100 is received in the cylindrical member 91 with the slight clearance in radial directions, and thus, no difficulty arises in admitting the atmospheric air.

### INDUSTRIAL APPLICABILITY

The negative pressure type booster device according to the present invention is suitable for use in a vehicle brake system for outputting a braking power by the manipulation of a brake pedal.

1-9. (canceled)

10. A negative pressure type booster device comprising:
a booster shell movably supporting a partition member which partitions the interior of the booster shell into a variable pressure chamber and a constant pressure chamber;
a valve piston secured to the partition member at a base portion thereof and having a negative pressure valve seat formed thereon for selective communication of the variable pressure chamber with the constant pressure chamber;
an output rod connected to the valve piston;
a reaction member for transmitting an output of the partition member depending on the pressure difference between the variable and constant pressure chambers, from the valve piston to the output rod;
a plunger operable in connection with the reaction member and having an atmosphere valve seat formed thereon;
an input rod connected to the plunger for axially moving the plunger when the input rod is axially moved by a brake pedal;
a valve member having a negative pressure valve and an atmosphere valve formed thereon, the negative pressure valve being contactable with the negative pressure valve seat of the valve piston for making the variable pressure chamber communicate selectively with the constant pressure chamber, the atmosphere valve being contactable with the atmosphere valve seat of the plunger for making the variable pressure chamber communicate selectively with the atmosphere; and
a silencer disposed in a passage for leading the atmospheric air to the atmosphere valve;
wherein a secondary passage communicating directly with the atmosphere is formed between an internal surface of a sliding cylindrical portion of the valve piston and an external surface of the silencer for enabling the atmospheric air to be admitted from the secondary passage to the variable pressure chamber when the input rod is advanced beyond a predetermined distance relative to the valve piston.

11. The negative pressure type booster device as set forth in claim 10, further comprising a filter element provided in the secondary passage and being smaller in air path resistance than the silencer.

12. The negative pressure type booster device as set forth in claim 10, further comprising:
a cylindrical member arranged between the internal surface of the sliding cylindrical portion of the valve piston and the external surface of the silencer to define the secondary passage; and
closing means for closing the communication of the secondary passage with the atmosphere valve seat at the time of an ordinary braking, but making the communication of the secondary passage with the atmosphere valve seat when the input rod is advanced beyond the predetermined distance relative to the valve piston.

13. The negative pressure type booster device as set forth in claim 12, wherein the cylindrical member is provided at an intermediate portion thereof with a stepped portion on which a communication passage opens to communicate with the secondary passage and wherein the closing means comprises:
a bypass valve member contactable to the stepped portion of the cylindrical member for closing the communication passage;
an urging member for urging the bypass valve member in a direction toward contact with the stepped portion of the cylindrical member; and
an operating portion extending from the input rod for pushing the bypass valve member forward against the resilient force of the urging member to open the communication passage when the input rod is advanced beyond the predetermined distance relative to the valve piston.

14. The negative pressure type booster device as set forth in claim 13, wherein the operating portion extending from the input rod extends in a radial direction perpendicular to a swing motion direction of the input rod given by the brake pedal.

15. The negative pressure type booster device as set forth in claim 12, wherein the cylindrical member is circumferentially positioned relative to the valve piston, the negative pressure type booster device further comprising:
an operating member provided coaxially with the input rod and radially extending an operating portion;
a position restriction portion provided on the cylindrical member for restricting the movement of the operating member relative to the cylindrical member in the circumferential direction
wherein the operating member has a guide aperture for allowing the input rod to swing but restricting the relative movement of the input rod in a radial direction perpendicular to the swing motion direction of the input rod.

16. The negative pressure type booster device as set forth in claim 10, further comprising:
a bypass valve member for selectively controlling the communication of the secondary passage with the atmosphere valve seat;
an operating member provided coaxially with the input rod for operating the bypass valve member to make the secondary passage communicate with the atmosphere valve seat when the input rod is advanced beyond the predetermined distance relative to the valve piston and having a round inner hole which does not interfere with the input rod during the swing motion of the same; and
a pair of slide guiding members provided on the input rod for guiding the operating member to be slidable radially relative to the input rod and for restraining the rearward position of the operating member on the input rod.

17. The negative pressure type booster device as set forth in claim 16, further comprising:
a cylindrical member received in the sliding cylindrical portion of the valve piston to define the secondary passage between the external surface thereof and the internal surface of the sliding cylindrical portion,
wherein a communication passage is formed on the cylindrical member for being selectively opened and closed by the bypass valve member, and
wherein the operating member is received within the cylindrical member with a slight clearance in radial directions.

18. The negative pressure type booster device as set forth in claim 16, wherein the operating member protrudes a plurality of slide guided portions in radial directions from the circumference thereof to define air passages between the slide guided portions.

19. The negative pressure type booster device as set forth in claim 16, further comprising a filter element provided in the secondary passage and being smaller in air path resistance than the silencer.

20. A negative pressure type booster device comprising:
a booster shell movably supporting a partition member which partitions the interior of the booster shell into a variable pressure chamber and a constant pressure chamber;
a valve piston secured to the partition member at a base portion thereof and having a negative pressure valve seat formed thereon for selective communication of the variable pressure chamber with the constant pressure chamber;
an output rod connected to the valve piston;
a reaction member for transmitting an output of the partition member depending on the pressure difference between the variable and constant pressure chambers, from the valve piston to the output rod;
a plunger operable in connection with the reaction member and having an atmosphere valve seat formed thereon;
an input rod connected to the plunger for axially moving the plunger when the input rod is axially moved by a brake pedal;
a valve member having a negative pressure valve and an atmosphere valve formed thereon, the negative pressure valve being contactable with the negative pressure valve seat of the valve piston for making the variable pressure chamber communicate selectively with the constant pressure chamber, the atmosphere valve being contactable with the atmosphere valve seat of the plunger for making the variable pressure chamber communicate selectively with the atmosphere;
a silencer disposed in a passage for leading the atmospheric air to the atmosphere valve;
a cylindrical member inserted into the valve piston to define a secondary passage communicating directly with the atmosphere between the internal surface of a sliding cylindrical portion of the valve piston and the external surface of the silencer, the cylindrical member having a stepped portion at an intermediate portion thereof and a communication passage formed to open on the stepped portion to communicate with the secondary passage;
a filter element provided in the secondary passage and being smaller in air path resistance than the silencer;
a bypass valve member movably inserted into the cylindrical member and being contactable with the stepped portion of the cylindrical member for closing the communication passage; and
a mechanism for effecting a relative displacement between the cylindrical member and the bypass valve member in connection with the axial movement of the input rod when the same is advanced relative to the valve piston beyond a predetermined distance, so that the atmospheric air from the secondary passage is led to the variable pressure chamber through the communication passage.

21. The negative pressure type booster device as set forth in claim 20, wherein the mechanism comprises:
an urging member for urging the bypass valve member in position to close the communication passage opening on the stepped portion; and
an operating member operable in dependence on the displacement of the input rod relative to the valve piston for moving the bypass valve member against the urging member.

22. The negative pressure type booster device as set forth in claim 21, wherein the operating member radially extends an operating portion in a radial direction perpendicular to a swing motion direction of the input rod, for pushing the bypass valve member forward against the urging member to open the communication passage when the input rod is advanced relative to the valve piston beyond the predetermined distance.

23. The negative pressure type booster device as set forth in claim 22, wherein the operating member has a guide aperture formed therein which is elongated in the swing motion direction of the input rod for allowing the input rod passing through the guide aperture to swing in the swing motion direction but restraining the movement of the operating member relative to the input rod in the radial direction perpendicular to the swing motion direction.

24. The negative pressure type booster device as set forth in claim 22, wherein the cylindrical member received in the internal surface of the valve piston is positioned relative to the valve piston in the circumferential direction, the negative pressure type booster device further comprising:
a position restraining portion provided on the cylindrical member for preventing the operating member from rotating relative to the valve piston in the circumferential direction.

25. The negative pressure type booster device as set forth in claim 24, wherein the position restraining portion includes:
a pair of inner ribs extending from an internal surface of the cylindrical member radially inwardly in the radial direction perpendicular to the swing motion direction to put the operating portion of the operating member therebetween in the swing motion direction.

26. The negative pressure type booster device as set forth in claim 22, wherein an operating member has a round inner hole which does not interfere with the input rod during the swing motion of the same and wherein the mechanism further comprises:
a pair of slide guiding members provided on the input rod for guiding the operating member to be slidable radially relative to the input rod and for restraining the rearward position of the operating member on the input rod.

27. The negative pressure type booster device as set forth in claim 26, wherein the operating member protrudes a plurality of slide guided portions in radial directions from the circumference thereof to define air passages between the slide guided portions.

28. The negative pressure type booster device as set forth in claim 27, wherein the operating member is received within the cylindrical member with a slight clearance in radial directions.
